(19) United States
(12) Patent Application Publication
(10) Pub. No.: US 2012/0195286 A1
(43) Pub. Date: Aug. 2, 2012

(54) APPARATUS AND METHOD FOR TRANSCEIVING SIGNALS IN A WIRELESS COMMUNICATION SYSTEM

(75) Inventors: Kitae Kim, Suwon-si (KR); Sungjun Yoon, Seoul (KR); Sungjin Suh, Seoul (KR); Kibum Kwon, Ansan-si (KR)

(73) Assignee: PANTECH CO., LTD., Seoul (KR)

(21) Appl. No.: 13/500,619

(22) PCT Filed: Oct. 5, 2010
(86) PCT No.: PCT/KR2010/006808

§ 371 Date: Apr. 5, 2012

(30) Foreign Application Priority Data
Oct. 6, 2009 (KR) 10-2009-0094868

(51) Int. Cl. H04W 72/04

(52) U.S. Cl. 370/330; 370/329

(57) ABSTRACT

The present specification relates to an apparatus and method for transceiving signals between a terminal and a base station in a wireless communication system. The present specification relates to a signal-transceiving method in which location reference signals discriminated by frequency units for each base station, such that base stations which transmit location reference signals with the same location reference signal pattern can be further discriminated.

### CROSS-REFERENCE TO RELATED APPLICATIONS

This application is the National Stage Entry of International Application PCT/KR2010/006808, filed on Oct. 5, 2010, and claims priority from and the benefit of Korean Patent Application No. 10-2009-0094868, filed on Oct. 6, 2009, both of which are incorporated herein by reference for all purposes as if fully set forth herein.

### BACKGROUND

1. Field

The present invention relates to a method and apparatus for transmitting and receiving a signal between a user equipment (UE) and a base station (BS) in a wireless communication system.

2. Discussion of the Background

As generally known in the art, a positioning method for providing various location services in Wideband Code Division Multiple Access (WCDMA) and location information required for communication may be classified into three methods, that is, a cell coverage-based positioning method, an observed time difference of arrival-idle period downlink (OTDOA-IPDL) method, and a network assisted GPS method. The methods do not compete against one another, but rather complement each other. Each method may be appropriately utilized for different purposes.

The OTDOA method may measure relative arrival times of reference signals (RSs) or pilots transmitted from different base stations (BSs) or different cells. To calculate a location, a user equipment (UE) or a mobile station (MS) may need to receive a corresponding RS from at least three different BSs or Cells. The WCDMA standard may include an idle period in downlink (IPDL) so as to readily perform the OTDOA location measurement and to avoid a near-far problem. During the idle period, a UE or an MS may need to receive an RS or a pilot from a neighbor cell although an RS or a pilot from a servicing cell where the UE is currently located is strong.

A Long Term Evolution (LTE) system, developed from WCDMA that is associated with the 3GPP, is based on an orthogonal frequency division multiplexing (OFDM) scheme as opposed to an asynchronous code division multiple access (CDMA) scheme of WCDMA. In the same manner that WCDMA performs positioning based on the OTDOA method as described in the foregoing, a new LTE system considers performing positioning based on the OTDOA method, and may consider a method that vacates, at regular intervals, a data region in each subframe structure of one of or both a multicast broadcast single frequency network (MBSFN) subframes and a normal subframe, and transmits an RS for positioning to the vacated region. That is, although positioning in LTE that is an OFDM-based new generation communication scheme is based on a conventional OTDOA method in WCDMA, a method of transmitting an RS for positioning in a new resource allocation structure and a configuration of the RS is required since a communication basis, such as multiplexing scheme, an access scheme, and the like, is changed. Also, demand for an accurate positioning method has been increased due to the development of a communication system, such as an increase in a movement speed of an UE, a change in interference environment between BSs, an increase in complexity of the interference environment, and the like.

### SUMMARY

The present disclosure provides a transceiving method that may distinguish a positioning reference signal (PRS) based on a frequency unit for each base station (BS) and thus, may distinguish BSs that transmit a PRS based on the same PRS pattern, and a system thereof.

Also, the present disclosure provides a method of performing grouping on a total frequency band of a BS, and applying different muting patterns for each grouped frequency band, and a system thereof.

In order to accomplish the above object, there is provided a method of transmitting a signal in a wireless communication system, the method including dividing, into L frequency bands, a total frequency band allocated to a frequency axis with respect to N consecutive subframes that are allocated for transmitting a positioning reference signal (PRS) at regular intervals, and performing muting by not transmitting a PRS to at least one frequency band with respect to at least one of the N subframes, and transmitting a PRS to remaining frequency bands.

In accordance with another aspect of the present invention, there is provided a transmitting apparatus, including a scrambler to scramble bits input in a form of code words after channel coding in a downlink, a modulation mapper to modulate the bits scrambled by the scrambler into a complex modulation symbol, a layer mapper to map a complex modulation symbol to one or more transmission layers, a pre-coder to perform pre-coding of a complex modulation symbol in each transmission channel of an antenna port, a resource element mapper to map a complex modulation symbol associated with each antenna port to a corresponding resource element, and a PRS resource allocator to map a PRS to the resource element.

In accordance with still another aspect of the present invention, there is provided a method of transmitting a reference signal, the method including selecting a first muting pattern that does not transmit a PRS in a first frequency-time domain that is defined by a first frequency domain of a total frequency band available to a base station (BS) and a first time domain of a transmission period of a PRS, transmitting information associated with the selected first muting pattern to a user equipment (UE), and generating a PRS based on the first muting pattern and transmitting the generated PRS.

### BRIEF DESCRIPTION OF THE DRAWINGS

FIG. 1 is a block diagram illustrating a wireless communication system according to an exemplary embodiment of the present invention.

FIG. 2 and FIG. 3 are diagrams illustrating patterns of a positioning reference signal (PRS), which is an example of a reference signal that is temporarily determined with respect to a single subframe in a current LTE system, in a case of a normal cyclic prefix (CP) and an extended CP with respect to a normal subframe.

FIG. 4 is a diagram illustrating a transmitting apparatus that generates and transmits a pattern of a PRS according to an exemplary embodiment of the present invention.

FIG. 5, FIG. 6, and FIG. 7 are diagrams illustrating a method of transmitting a PRS based on a muting pattern with respect to an arbitrary N and K according to another exemplary embodiment of the present invention.

FIG. 8 is a diagram illustrating a frequency muting method that transmits a PRS based on a frequency band-based muting pattern according to another exemplary embodiment of the present invention.

FIG. 9 is a diagram illustrating a correlation between logical frequency division and physical frequency division for frequency muting that transmits a PRS based on a frequency band-based muting pattern.

FIG. 10 is a diagram illustrating a frequency muting method that transmits a PRS based on a frequency band-based muting pattern when L corresponding to a number of divided frequency bands is 2.

FIG. 11 is a diagram illustrating a frequency muting method that transmits a PRS based on a frequency band-based muting pattern when L corresponding to a number of divided frequency bands is 2.

FIG. 12, FIG. 13, and FIG. 14 are diagrams illustrating a hybrid-type based muting method of FIG. 11 when a number of consecutive PRS subframes allocated for transmitting a PRS is 2, 4, or 6.

FIG. 15 is a diagram illustrating a frequency muting method that transmits a PRS based on a frequency band-based muting pattern when L corresponding to a number of divided frequency bands is 3.

FIG. 16 is a diagram illustrating a method of transmitting a PRS by arranging a BS or a cell according to the same muting pattern based on a single cell-site unit including a plurality of cells according to another exemplary embodiment of the present invention.

FIG. 17 is a diagram illustrating a method of transmitting a PRS by arranging, based on a corresponding muting pattern, a BS or a cell in each sector or each cell of a single cell-site including a plurality of cells according to another exemplary embodiment of the present invention.

FIG. 18 is a block diagram illustrating a user equipment (UE) according to another exemplary embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

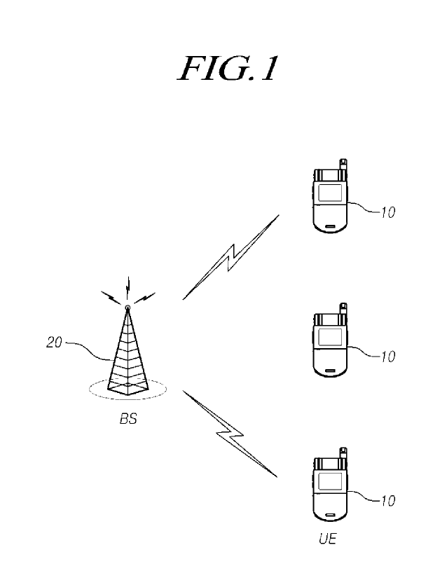

FIG. 1 illustrates a wireless communication system according to an exemplary embodiment of the present invention.

The wireless communication system is widely installed to provide various communication services, such as voice data, packet data, and the like.

Referring to FIG. 1, the wireless communication system may include a user equipment (UE) 10 and a base station (BS) 20. The UE 10 and the BS 20 may use various power allocation methods described in the below.

The UE 10 may be an inclusive concept indicating a user terminal in a wireless communication, and the concept may include a UE in WCDMA, LIE, HSPA, and the like, a mobile station (MS), a user terminal (UT), a subscriber station (SS), a wireless device in GSM, and the like.

In general, the BS 20 or a cell may refer to a fixed station where communication with the UE 10 is performed, and may also be referred to as a Node-B, an evolved Node-B (eNB), a base transceiver system (BTS), an access point, and the like.

That is, the BS 20 or the cell may be an inclusive concept indicating a portion of an area covered by a base station controller (BSC) in CDMA and a Node B in WCDMA, and the concept may include coverage areas, such as a megacell, macrocell, a microcell, a picocell, a femtocell, and the like.

The UE 10 and the BS 20 are used as two inclusive transceiving subjects to embody the technology and technical concepts described in the specifications, and may not be limited to a predetermined term or word.

A multiple access scheme applied to the wireless communication system is not limited. The wireless communication system may utilize varied multiple access schemes, such as Code Division Multiple Access (CDMA), Time Division Multiple Access (TDMA), Frequency Division Multiple Access (TDMA), Orthogonal Frequency Division Multiple Access (OFDMA), OFDM-FDMA, OFDM-TDMA, OFDM-CDMA, and the like.

Uplink (UL) transmission and downlink (DL) transmission may be performed based on a time division duplex (TDD) scheme that performs transmission based on different times, or based on a frequency division duplex (FDD) scheme that performs transmission based on different frequencies.

Exemplary embodiments of the present invention may be applicable to resource allocation in an asynchronous wireless communication scheme that is advanced through GSM, WCDMA, and HSPA, to be LTE and LIE-advanced, and may be applicable to resource allocation in a synchronous wireless communication scheme that is advanced through CDMA and CDMA-2000, to be UMB. Exemplary embodiments of the present invention may not be limited to a specific wireless communication, and may be applicable to all technical fields to which a technical idea of the present invention is applicable.

An exemplary embodiment may provide a method of dividing a frequency resource and a time resource for transmission of a reference signal (RS) of a UE. Examples of the RS may include a channel state information reference signal (CSI-RS), a demodulation reference signal (DM-RS), and the like. In addition, a signal transmitted and received between a UE and a BS as a reference signal or a standard signal, may be included. Hereinafter, description will be provided based on a positioning reference signal (PRS) among the example of the RS.

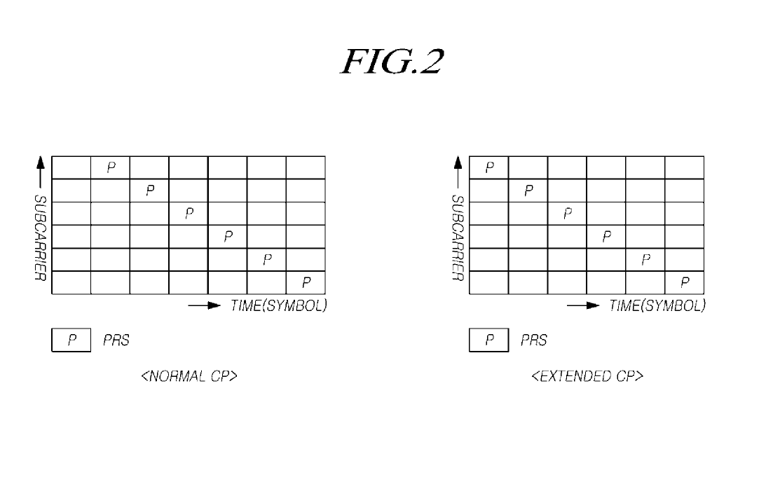

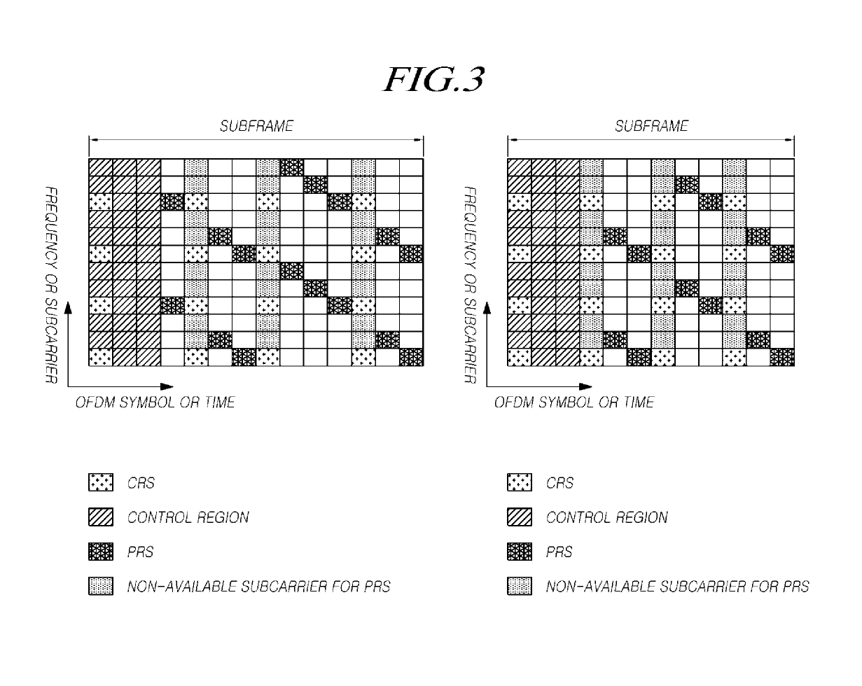

FIG. 2 and FIG. 3 illustrate patterns of a PRS, which is an example of a reference signal that is temporarily determined with respect to a single subframe in a current LTE system, in a case of a normal cyclic prefix (CP) and an extended CP with respect to a normal subframe

1. A basic PRS pattern is formed in ½ of a resource block including two slots and six subcarriers, based on a predetermined sequence. An example of the predetermined sequence may be {0, 1, 2, 3, 4, 5}. Also, the two slots may be two time slots forming a positioning subframe. Here, a method of forming the basic PRS pattern based on the predetermined sequence may be provided as follows.

1-a) When the predetermined sequence f(i)={f(0), f(1), f(2), f(3), f(4), f(5)}={0, 1, 2, 3, 4, 5}, a PRS pattern is formed in a location of a subcarrier, on a frequency domain, corresponding to a first value of the sequence in a last symbol of each of two slots. That is, for the last symbol, the first value of the sequence is 0 and thus, the PRS pattern is formed in a location of a zeroth subcarrier. For a second symbol from the last symbol, a PRS pattern is formed in a location of a subcarrier, on a frequency domain, corresponding to a second value of the sequence. That is, for the second symbol from the last symbol, the second value of the sequence is 1 and thus, the PRS pattern is formed on a location of a first subcarrier. In the same manner, for each symbol from the last symbol to a sixth symbol in each of the two slots, a PRS pattern is formed in a location of a subcarrier, on a frequency domain, corresponding to a corresponding value of the sequence

1-b) A PRS pattern formed in a location corresponding to a control region such as a physical downlink control channel (PDCCH), a physical hybrid-ARQ indicator channel (PHICH), and a physical control format indicator channel (PCFICH), and the like, a symbol axis where a cell-specific reference signal (CRS) exists, and a reference element (RE) where a primary synchronization signal (PSS), a secondary synchronization signal (SSS), and a broadcast channel (BCH) exist, may be punctured from the basic PRS pattern.

1-equation) A process of forming the basic PRS pattern based on 1-a) and 1-b) may be expressed by the following equation.

v denotes a value defining a location on a frequency domain with respect to different PRSs, and N_{symb}^{DL} denotes a total number of OFDM symbols in each slot in a downlink. In this example, the basic PRS pattern with respect to a corresponding lth OFDM symbol in each slot may be formed by Equation 1.

$$v = 5 - l + {N}_{CP} \\ l = {N}_{symb}^{DL} - i , \\ for i = 1 , 2 , 4 , … , 4 + ( {n}_{s} mod 2 ) + {N}_{CP} \\ {N}_{CP} = \{ \begin{matrix}1 & for normal CP \\ 0 & for extended CP\end{matrix} \qquad [ [ Equation 1 ]$$

When a normal CP is used, N_{symb}^{DL} may be 7, and when an extended CP is used N_{symb}^{DL} may be 6. In a case of an even slot, (nₛ mod 2) may be 0. In a case of an odd slot, (nₛ mod 2) may be 1. Accordingly, in Equation 1, l may be expressed as follows.

$$l = \{ \begin{matrix}2 , 3 , 5 , 6 & if {n}_{5} mod 2 = 0 and {N}_{CP} = 1 \\ 1 , 2 , 3 , 5 , 6 & if {n}_{5} mod 2 = 1 and {N}_{CP} = 1 \\ 2 , 4 , 5 & if {n}_{5} mod 2 = 0 and {N}_{CP} = 0 \\ 1 , 2 , 4 , 5 & if {n}_{5} mod 2 = 1 and {N}_{CP} = 0\end{matrix}$$

2. The basic PRS pattern formed in ½ of the resource block that includes two slots forming a single subframe and six subcarriers may be allocated with respect to a frequency axis up to a system bandwidth, and with respect to a time axis up to Nsubframe subframes at regular intervals.

For example, when the system bandwidth is 10 Mhz, 50 resource blocks (RBs) exist and thus, the basic PRS pattern formed in ½ of the RB may be repeated as is 100 times with respect to the frequency axis. When a total number of RBs corresponding to a downlink system bandwidth is N_{RB}^{DL}, the basic PRS pattern may be repeated 2·N_{RB}^{DL} times.

The basic PRS pattern may be allocated to the Nsubframe subframes at regular intervals with respect to the time axis. Unlike the frequency axis, the basic PRS pattern may be allocated to be different for each system frame number (SFN: a single SFN includes 10 subframes) and for each piece of cell-specific information, such as, physical cell identity (PCI) and the like, and the allocation may be time-varying allocation. A value of defining a location on a frequency domain for PRSs that are different for each SFN and for the cell-specific information may be v_{shift} corresponding to a value that is additionally shifted from v with respect to a frequency axis and thus, a location of a subcarrier where a PRS is formed in each symbol may be equivalently cyclic-shifted by v_{shift}.

When the step 2 is applied to a Kth subcarrier in a total system bandwidth including N_{RB}^{DL}N_{sc}^{RB} subcarriers, it may be expressed by Equation 2. In this example, N_{RB}^{DL} denotes a total number of RBs corresponding to a downlink system bandwidth, N_{sc}^{RB} denotes a number of subcarriers in a single RB, and a normal subframe that is configured to be a positioning subframe may be based on Equation 2.

k=6m+(v+v_{shift})mod 6

m=0, 1, . . . , 2·N_{RB}^{DL}−1 [Equation 2]

Here, a value that defines a location on a frequency domain for the different PRSs may be v as described in the step 1, v_{shift} may be a value to equivalently cyclic-shift a location of a subcarrier where a PRS is formed in each symbol based on a SFN and cell-specific information. In this example, v_{shift} may correspond to a remainder obtained when a value generated based on a function of an SFN and cell-specific information is divided by an available total frequency shift value, 6. Particularly, at least one pseudo-random sequence value may be obtained from a pseudo-random sequence that is generated using cell-specific information, such as a PCI, as an initial value, through use of a function including a positioning SFN. The obtained at least one pseudo-random sequence value may be multiplied by a constant, the at least one multiplied value may be added up, and the sum may be divided by the available total frequency shift value, 6, so as to obtain the remainder. This may be expressed by Equation 3.

$$\begin{matrix}{v}_{shift} = f ( {n}_{subframe} , {N}_{cell}^{ID} ) \to {v}_{shift} \\ = ( {\sum }_{i} {a}^{i} \cdot c ( f ( {n}_{subframe} , i ) ) ) mod 6\end{matrix} \qquad [ Equation 3 ]$$

Here, 0≦N_{Cell}^{ID}<504 denotes a physical cell ID (PCI), a denotes a constant, c(i) denotes a pseudo-random sequence, and an initial value of c is cᵢₙᵢₜ=N_{Cell}^{ID} and it may be initialized for each subframe for positioning.

The step 1 and the step 2 may be expressed by an equation as follows.

That is, a PRS sequence r_{l,n}_{ₛ}(m) mapped to a complex-valued modulation symbol a_{k,l}^{(p)} that is used as a positioning reference symbol for an antenna port p in nₛth slot, may be expressed by Equation 4.

$${a}_{k , l}^{( p )} = {r}_{l , {n}_{s}} ( {m}^{′} ) \\ k = 6 m + ( V + {V}_{shift} ) mod 6 \\ l = {N}_{sym}^{DL} - i , \\ for i = 1 , 2 , 4 , … , 4 + ( {n}_{s} mod 2 ) + {N}_{CP} \\ m = 0 , 1 , … , 2 \cdot {N}_{RB}^{DL} - 1 \\ {m}^{′} = m + {N}_{RB}^{maxDL} - {N}_{RB}^{DL} \\ {N}_{CP} = \{ \begin{matrix}1 & for normal CP \\ 0 & for extended CP\end{matrix} \qquad [ Equation 4 ]$$

In Equation 4, l may be expressed as follows.

$$l = \{ \begin{matrix}2 , 3 , 5 , 6 & if {n}_{5} mod 2 = 0 and {N}_{CP} = 1 \\ 1 , 2 , 3 , 5 , 6 & if {n}_{5} mod 2 = 1 and {N}_{CP} = 1 \\ 2 , 4 , 5 & if {n}_{5} mod 2 = 0 and {N}_{CP} = 0 \\ 1 , 2 , 4 , 5 & if {n}_{5} mod 2 = 1 and {N}_{CP} = 0\end{matrix}$$

In this example, v and v_{shift} that are values of defining locations on a frequency domain for different PRSs may be expressed by Equation 5. Particularly, v_{shift} may be a value specialized for a cell-specific and a positioning SFN.

$$v = 5 - l + {N}_{CP} \\ \begin{matrix}{v}_{shift} = f ( {n}_{subframe} , {N}_{cell}^{ID} ) \to {v}_{shift} \\ = ( {\sum }_{i} {a}^{i} \cdot c ( f ( {n}_{subframe} , i ) ) ) mod 6\end{matrix} \qquad [ Equation 5 ]$$

In Equation 5, n_{subframe} denotes a positioning SFN, and an initial value of c in pseudo-random sequence c(i) is cᵢₙᵢₜ=N_{Cell}^{ID} and the initival value may be initialized for each subframe for positioning.

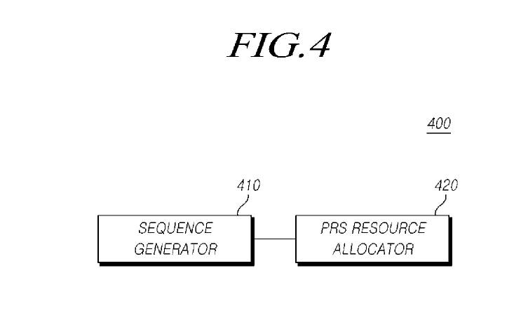

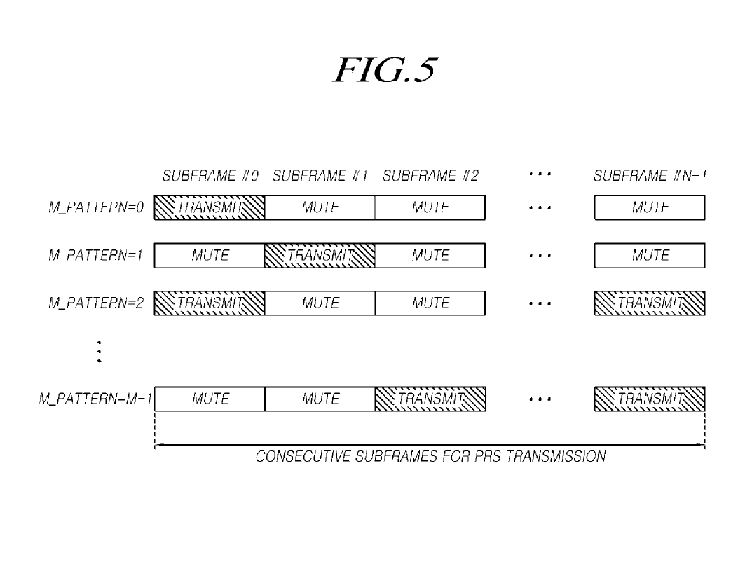

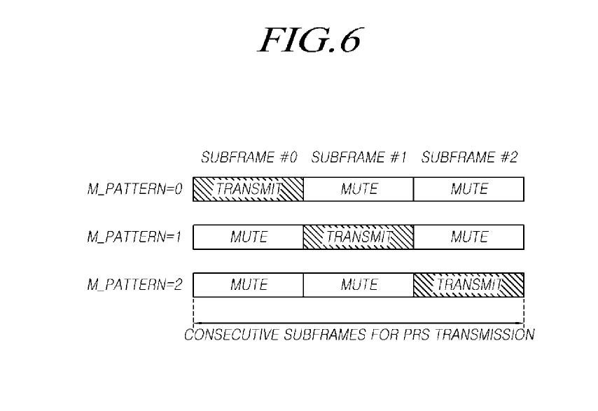

FIG. 4 illustrates a transmitting apparatus that generates and transmits a pattern of a PRS according to an exemplary embodiment of the present invention.

Referring to FIG. 4, a transmitting apparatus 400 that generates and transmits a pattern of a PRS may include a sequence generator 410 and a PRS resource allocator 420. The sequence generator 410 may generate a sequence for a PRS as described in the foregoing. The PRS resource allocator 420 may allocate PRSs to resource elements based on the PRS sequence generated by the sequence generator 110 according to a PRS pattern and a muting pattern. Subsequently, the PRSs allocated to the resource elements may be multiplexed with a BS transmission frame. Here, the PRS pattern may be a PRS transmission pattern that is defined within a single subframe, and the muting pattern may be a subframe-based PRS transmission pattern in which a PRS pattern is basically defined.

The PRS resource allocator 420 may allocate a resource associated with an OFDM symbol (x-axis) and a location of a subcarrier (y-axis) based on a predetermined rule so as to allocate a resource for a PRS, and may multiplex the allocated resource with a BS transmission frame at a predetermined frame timing.

Hereinafter, a signal generating structure of a downlink physical channel of a wireless communication system will be described with reference to FIG. 4. The signal generating structure of the downlink physical channel of the wireless communication system may omit, replace or change elements, and may add other elements.

Bits input in a form of code words after channel coding in a downlink may be scrambled by a scrambler, and may be input to a modulation mapper. The modulation mapper may modulate the scrambled bits into a complex modulation symbol. A layer mapper may map the complex modulation symbol to one or more transmission layers. Subsequently, a pre-coder may perform pre-coding of a complex modulation symbol in each transmission channel of an antenna port. Subsequently, a resource element mapper may map a complex modulation symbol with respect to each antenna port to a corresponding resource element. The PRS resource allocator 420 may form a PRS pattern based on the sequence generated by the sequence generator 410, and may perform mapping of a PRS.

That is, the PRS resource allocator 420 may allocate a PRS that is generated based on a predetermined PRS sequence after going through at least one of the described devices, to resource elements corresponding to resources where a predetermined OFDM symbol (time-axis) and a subcarrier (frequency-axis) are located, based on a PRS pattern generated based on the sequence, and may multiplex the allocated PRS with a BS transmission frame at a predetermined frame timing.

In this example, existing reference signals (RSs), control signals, and data input from the pre-coder may be allocated by the resource element mapper to resource elements corresponding to resources where a predetermined OFDM symbol (time-axis) and a subcarrier (frequency-axis) are located. Here, a device that provides an additional function (generating of a PRS pattern and mapping of a PRS) to the resource element mapper so as to allocate a PRS to a corresponding resource element, may correspond to a PRS mapping unit.

Subsequently, the OFDM signal generator may generate a complex time domain OFDM signal for each antenna. The complex time domain OFDM signal may be transmitted through an antenna port.

As illustrated in FIG. 3 and FIG. 4, a PRS pattern with respect to a single subframe and one RB along a frequency axis may be copied and transmitted up to a system bandwidth with respect to the frequency axis, and may be transmitted at regular intervals, such as 160 ms (160 subframes), 320 ms (320 subframes), 640 ms (640 subframes), or 1280 ms (1280 subframes), with a predetermined offset with respect to a time axis, through use of consecutive subframes, such as 1 subframe, 2 subframes, 4 subframes, or 6 subframes. In this example, in each BS 20, a bandwidth associated with a frequency axis for a PRS, a period of a subframe used for transmission of a PRS and an offset associated with a time axis, and a number of consecutive subframes used for transmission of a PRS may be controlled by a higher layer, and the information may be transmitted to each UE 10 through a higher layer, for example, a radio resource controller (RRC). In this example, the offset period, the number of allocated subframes, and the like used in the PRS pattern are merely examples, and may be variously changed.

In this example, a cell-specific subframe configuration period (TPRS) for transmission of a PRS may be 160, 320, 640, and 1280 subframes, and a cell-specific subframe offset may be [IPRS], [IPRS-160], [IPRS-480], and [IPRS-1120]. In this example, the PRS configuration index IPRS may be determined by a higher layer.

A PRS to be used for estimating a location of a user may be transmitted during a predetermined time unit. For more accurate positioning, a time variant pattern or a time non-variant pattern may be transmitted during twice an amount of the determined time. For example, when 1 subframe is a minimum unit for transmitting a PRS, PRSs may be transmitted through 2, 3, 4, . . . , N subframes. In this example, when a pattern of a PRS transmitted to each subframe is a time non-varying pattern, the pattern may be the same for each subframe. When the pattern is time varying pattern, the pattern may be different for each subframe.

Specifically, as illustrated in FIG. 3 and FIG. 4, when a PRS pattern is cyclic-shifted with respect to the frequency axis, a number of distinguished patterns may be 6. Accordingly, BSs 20 may be classified into 6 groups, and each group may perform transmission based on different PRS patterns. However, when it is assumed that BSs 20 within Tier 2 based on the UE 10 are considered (here, although BSs beyond Tier 2 transmit PRSs, a signal to the corresponding UE is weak and thus, BSs from which the UE substantially receives signals are considered to be BSs within Tier 2), BSs 20 corresponding to 19 cell sites or 57 cells may exist and thus, the BSs 20 within Tier 2 may not be able to transmit PRSs having different patterns for each BS through use of the 6 PRS patterns. Also, a plurality of BSs 20 having the same PRS pattern may exist and inter-cell interference may occur that prevent distinguishing all PRSs transmitted from neighbor BSs during PRS transmission between BSs and thus, performance may be deteriorated. In this communication environment, interference may occur among cells using the same PRS pattern and thus, the accurate detection of a PRS may be difficult and a number of detected cells may be decreased.

When a PRS is transmitted based on at least a minimum time unit, that is, when a PRS is transmitted based on at least one subframe, PRSs may be transmitted to all the determined N subframes. Also, a predetermined BS 20 may not transmit a PRS. Accordingly, interference occurring when PRSs are transmitted among BSs may be reduced and thus, performance may be improved.

To reduce interference of a PRS, a BS may select a first muting pattern that does not transmit a PRS in a first frequency-time domain defined by a first frequency domain of an available total frequency band and a first time domain of a transmission period of a PRS, may share first muting pattern information with a UE through an RRC and the like, and may generate and transmit a PRS based on the first muting pattern.

Particularly, a total frequency domain is divided into L frequency domains and the transmission period is divided into K periods so that a total frequency-time domain may be distinguished by L×K frequency-time domains, and the first frequency-time domain may include one or more frequency-time domains from among the L×K frequency-time domains.

Also, the first muting pattern may denote the first frequency-time domain from among the L×K frequency-time domains, the BS may transmit a PRS based on the first muting pattern, and a second BS in a neighbor cell of the BS may transmit a PRS based on a second muting pattern indicating a second frequency-time domain including one or more frequency-time domains, different from the first frequency-time domain, from among the L×K frequency-time domains and thus, a probability that PRSs of the BSs interfere with each other may be decreased.

The PRS pattern as described with reference to FIG. 2 may be a PRS pattern that performs transmission in the second frequency-time domain as opposed to the first frequency-time domain. That is, the first frequency-time domain may be a domain that does not transmit a PRS and thus, the second frequency-time domain may transmit a PRS. Also, a sequence for a PRS may be generated based on a PRS pattern (when a PRS is transmitted within a subframe.

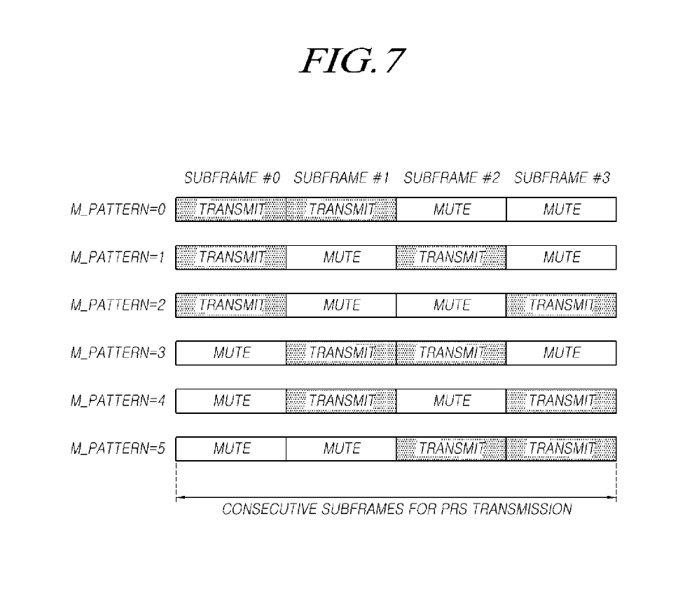

FIG. 5, FIG. 6, and FIG. 7 illustrate a method of transmitting a PRS based on a muting pattern with respect to an arbitrary N and K according to another exemplary embodiment of the present invention. FIG. 5 illustrates a method of transmitting a PRS based on a general muting pattern. FIG. 6 illustrates a method of transmitting a PRS based on a muting pattern when N=3, K=1, and a number of cell groups (M)=3. FIG. 7 illustrates a method of transmitting a PRS based on a muting pattern when N=4, K=2, and M=6. Here, M may correspond to a number of total cell groups including persistent muting cell groups that perform muting by not transmitting a PRS with respect to all N subframes allocated for transmitting a PRS during a predetermined period.

Referring to FIG. 5, FIG. 6, and FIG. 7, when subframes are allocated for transmitting a PRS during subframes from zeroth to N-lth subframe, transmission may be performed by dividing the subframes into ‘Transmit’ subframe sections that transmit a PRS and ‘mute’ subframe sections that do not transmit a PRS.

That is, N (N=1, 2, 4, or 6) consecutive subframes may be allocated for transmitting a PRS at regular intervals (160 ms, 320 ms, 640 ms, or 1280 ms, a single subframe corresponding to 1 ms), and each BS 20 or cell group may transmit a PRS to K subframes (‘transmit’ subframes) from among the N subframes, and may perform muting N-K subframes by not transmitting a PRS to N-K subframes (‘Mute’ subframes). In this example, a PRS pattern associated with the K subframes that transmit a PRS and the N-K subframes that perform muting by not transmitting a PRS may be copied and transmitted up to a system bandwidth for a PRS with respect to a frequency axis.

A time when a PRS is transmitted for each BS may be additionally distinguished based on a subframe unit so that BSs that transmit a PRS based on the same PRS pattern may be distinguished. In this manner, by taking into consideration effects from interference occurring among BSs and a local characteristic of a BS, more excellent performance may be obtained than by using a scheme that transmits a PRS to all subframes. That is, when subframes that transmit a PRS are adjusted by applying a muting pattern, a limited number of PRS patterns may be increased and interference caused by neighbor cells may be reduced. Therefore, the limited PRS patterns may have diversity and thus, an accuracy of positioning may be expected to be improved.

The muting pattern expressed in FIG. 5, FIG. 6, and FIG. 7 may provide an effect of increasing a number of basic PRS patterns, which is relatively limited.

In this example, the UE 10 may require additional information since the UE 10 may need to be aware of a muting pattern used by each cell. The UE 20 may need information associated with a time-offset of a serving cell and measured cells, a cell ID, and the like. In particular, secondary data associated with the serving cell may include a bandwidth for PRSs, a PRS configuration index, and a number of consecutive downlink subframes NPRS. Secondary data associated with the measured cell may include a PCI, a timing offset, a normal or extended CP, an antenna port configuration, and a slot number offset.

The muting pattern may be cell-specific information and thus, muting pattern information of both the serving cell and the measured cell may need to be broadcasted to the target UE 10 through a higher layer signaling. The muting pattern may select K subframes from among the N consecutive PRS subframes for transmission of a PRS. In this example, a number of available selections may be M, and M=_{N}C_{K}(K=└N/2┘ or ┌N/2┐).

Accordingly, bits to be additionally provided to the UE 10 through the higher layer signaling may be ┌log₂M┐ per cell. For example, N=3, K=1, and M=3 and thus, the transmission of additional information of ┌log₂3┐=2 bit per cell may be required. When a number of service cells and measured cells is 57 (at least Tier 2 in the 3-sector cell environment), additional information of 2×57=114 bits may be required to transmitted to the target UE 10. Referring to FIG. 7, N=4, K=2, and M=6, and thus, additional bits per cell may be 3 bits. When the number of the serving cells and the measured cells is 57, additional information of 171 bits may be required to be transmitted to the target UE 10. Accordingly, as a number of the consecutive PRS subframes (N) increases, K proportionally increases. As K increases, a total number of muting patterns (M) also increases. Accordingly, information to be broadcasted by each cell may be rapidly increased.

The muting pattern may be formed as shown in the combination of FIG. 7 based on set K. Referring to FIG. 7, a number of muting patterns is 6, and when the muting pattern is combined with a basic PRS pattern, 36 combined PRS-muting patterns may be formed. However, a number of orthogonal patterns is not substantially increased due to interference caused by measured cells for each subframe. Inter-cell interference may be decreased by about ½, as shown in FIG. 7.

The PRS pattern may be allocated to a basically given total bandwidth and thus, a frequency-diversity may be sufficiently obtained by applying a muting pattern. However, time-axis transmission, corresponding to a number of subframes that perform muting on the all subframes allocated for transmitting a PRS by not transmitting a PRS to the all subframes, may not be performed and thus, a time-diversity may be insufficiently obtained.

Hereinafter, a frequency band-based muting method for transmitting a PRS will be described according to another exemplary embodiment. The other exemplary embodiment may configure a muting pattern through simple division of a frequency band, and may reduce a number of cells that use the same resource so as to effectively reduce inter-cell interference.

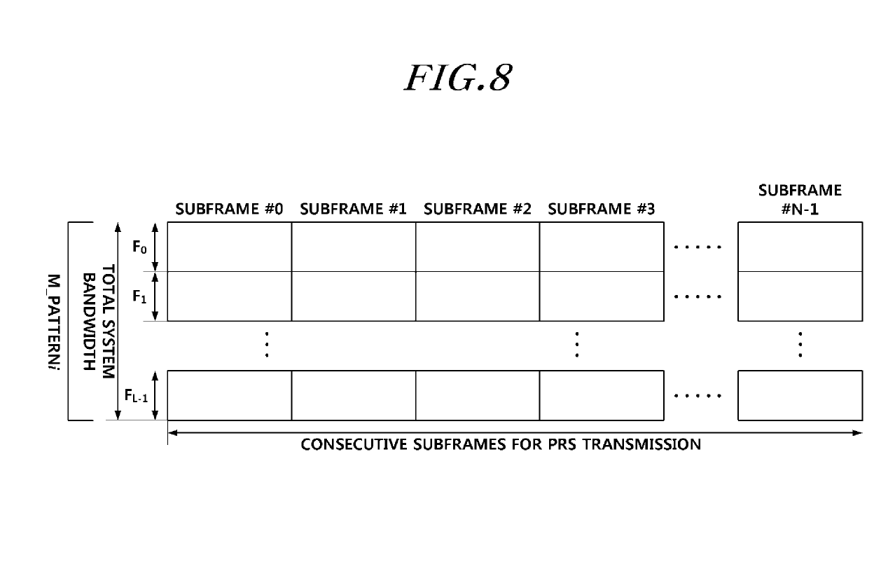

FIG. 8 illustrates a frequency muting method that transmits a PRS based on a frequency band-based muting pattern according to another exemplary embodiment of the present invention.

Referring to FIG. 8, each BS group may divide, into L frequency bands, the total frequency band allocated to a wireless communication system along a frequency axis with respect to N (N=1, 2, 4, or 6) consecutive subframes that are allocated for transmitting a PRS at regular intervals (160 ms, 320 ms, 640 ms, or 1280 ms, a single subframe corresponding to 1 ms), may transmit a PRS to at least one predetermined frequency band, and may perform muting by not transmitting a PRS to remaining frequency bands.

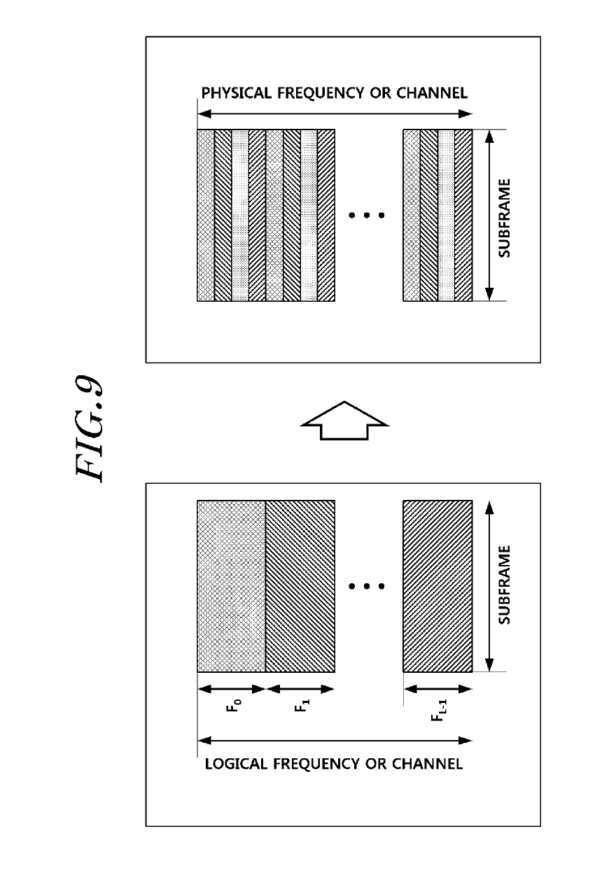

FIG. 9 illustrates a correlation between logical frequency division and physical frequency division for frequency muting that transmits a PRS based on a frequency band-based muting pattern.

Division of a frequency band may not always indicate physical division of a frequency. The division of a frequency band may include a logical division of a frequency or a channel as illustrated in FIG. 9. Accordingly, the logical frequency division may be the same as the physical frequency division, or may be different from the physical frequency division.

Referring to FIG. 9, when a frequency band is divided into L frequency bands (F0 through FL-1) based on a logical frequency division, a predetermined frequency band, for example, a frequency band F0 may be physically dispersed into a frequency axis as illustrated on the right of FIG. 9.

By taking into consideration an arrangement of cells in the dispersed frequency bands, a PRS may be transmitted only to at least one predetermined frequency band, and a PRS may not be transmitted to remaining frequency bands so that the remaining frequency bands may be muted and thus, inter-cell interference may be reduced. At the same time, transmission may be continuously performed in a time-domain and thus, a sufficient time-diversity may be obtained during a consecutive PRS subframe section defined for transmission of a PRS.

Also, physical locations of PRSs or a density per unit area may not be changed by applying the frequency muting described in the foregoing with reference to FIG. 5, FIG. 6, FIG. 7, and FIG. 8 and thus, a measurement error caused by a change in a physical location of a PRS or a reduced density, which may be used for time muting that is described with reference to FIG. 5, FIG. 6, and FIG. 7, may not occur. Also, a hybrid-type that sufficiently obtains a frequency-diversity through alternate allocation to the divided frequency bands, may be readily defined and thus, it may be readily introduced in a multi-cell environment.

According to another exemplary embodiment, although L corresponding to a number of divided frequency bands may not be limited, the number of divided bands may be adjusted based on a length of a pseudo-random sequence associated with a requirement of a wireless communication system.

Hereinafter, although a total frequency band is divided into two or three frequency bands for ease of description, the number of divided frequency bands may not be limited thereto.

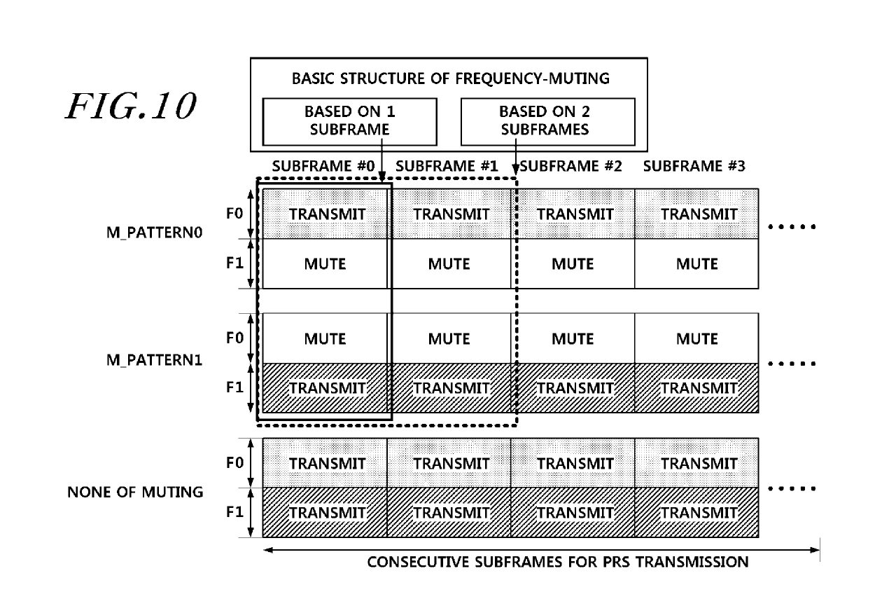

FIG. 10 illustrates a frequency muting method that transmits a PRS based on a frequency band-based muting pattern when L corresponding to a number of divided frequency bands is 2.

Referring to FIG. 10, a total frequency band allocated to a wireless communication system along a frequency axis with respect to N (N=1, 2, 4, or 6) consecutive subframes allocated for transmitting a PRS at regular intervals (160 ms, 320 ms, 640 ms, or 1280 ms, a single subframe corresponding to 1 ms) may be divided into two frequency bands. In this example, an even frequency-band in the two frequency bands may correspond to a lower frequency band (F1), and an odd frequency-band in the two frequency bands may correspond to the remaining higher frequency band (F0).

The wireless communication system may group the BSs into three BS groups, that is, cell groups 1 through 3. The cell group 1 may transmit a PRS to the odd frequency band (F0) from among the total frequency band allocated to the wireless communication system along the frequency axis with respect to the N (N=1, 2, 4, or 6) consecutive subframes, and may mute the even frequency band (F1) by not transmitting a PRS to the even frequency band (F1).

The cell group 2 may transmit a PRS to the even frequency band (F1) from among the total frequency band allocated to the wireless communication system along the frequency axis with respect to the N (N=1, 2, 4, or 6) consecutive subframes, and may mute the odd frequency band (F0) by not transmitting a PRS to the odd frequency band (F0).

The cell group 3 may transmit a PRS to the total frequency band allocated to the wireless communication system along the frequency axis with respect to the N (N=1, 2, 4, or 6) consecutive subframes, that is, both the odd frequency band (F0) and the even frequency band (F1). In this example, the cell group 3 may mute the total frequency band by not transmitting a PRS to the total frequency band allocated to the wireless communication system along the frequency axis.

A PRS may be distinguished by dividing, into two frequency bands, the total frequency band allocated to the wireless communication system along the frequency axis with respect to the N (N=1, 2, 4, or 6) consecutive subframes that are allocated for transmitting a PRS at regular intervals, and by grouping the BSs into three groups. Accordingly, since a number of BSs distinguished with respect to a time and a frequency is determined to be 6 based on different PRS patterns, BSs 20 may be distinguished in a total of 18 ways.

Although a PRS is transmitted by distinguishing BSs based on the method of FIG. 10, each BS uses a predetermined frequency band and thus, a performance may be deteriorated in association with frequency band.

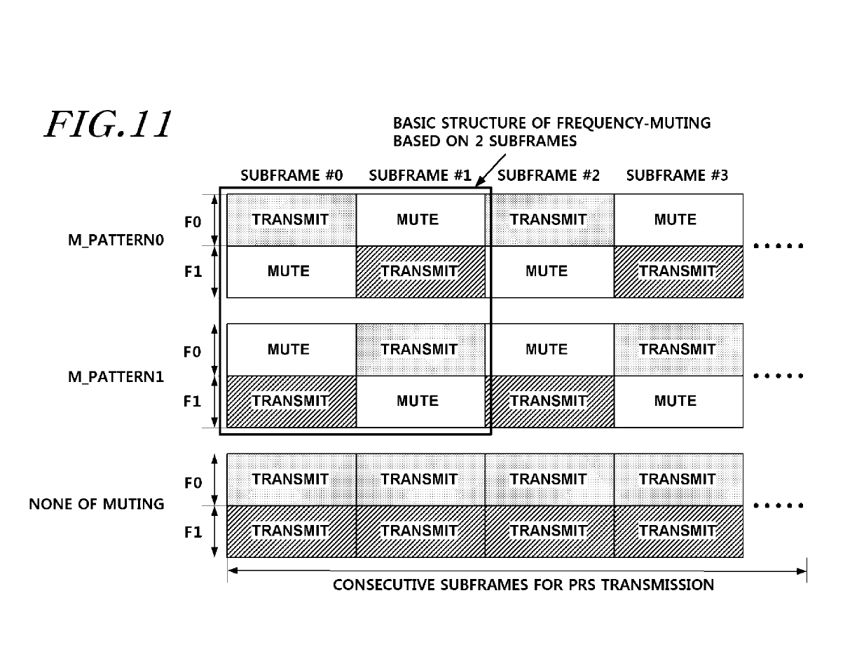

FIG. 11 illustrates a frequency muting method that transmits a PRS based on a frequency band-based muting pattern when L corresponding to a number of divided frequency bands is 2.

Referring to FIG. 11, a total frequency band allocated to a wireless communication system along a frequency axis with respect to N consecutive subframes that are allocated for transmitting a PRS at regular intervals may be divided into two frequency bands.

The wireless communication system may group BSs into three BSs group, that is, cell groups 1 through 3. Based on a two-subframe unit, the cell group 1 (M_pattern=0) may transmit a PRS in an odd subframe, such as, a first subframe, a third subframe, and the like, of an odd frequency band (F0) from among the N consecutive subframes, and may mute an even subframe, such as, a second subframe, a fourth subframe, and the like, by not transmitting a PRS or transmitting a PRS with zero (0) power. Also, the cell group 1 may transmit a PRS in an even subframe of an even frequency band (F1) and may mute an odd subframe by not transmitting a PRS or transmitting a PRS with zero (0) power. In FIG. 11, the odd subframes may be subframe #0, #2, and the like, and the even subframes may be subframes #1, #3, and the like. Throughout the specification, an odd/even subframe according to an exemplary embodiment may correspond to the above configuration.

Conversely, based on a two-subframe unit, the cell group 2 (M_pattern=1) may transmit a PRS in the even subframe of the odd frequency band (F0) from among the N consecutive subframes, and may mute the odd subframe by not transmitting a PRS or transmitting a PRS with zero (0) power. Also, the cell group 2 may transmit a PRS in the odd subframe of the even frequency band (F1), and may mute an even subframe by not transmitting a PRS or transmitting a PRS with zero (0) power.

The cell group 3 (none of muting) may transmit a PRS to the total frequency band allocated to the wireless communication system along the frequency axis with respect to the N consecutive subframes, that is, both the odd frequency band (F0) and the even frequency band (F1). In this example, the cell group 3 may mute the total frequency band allocated to the wireless communication system along the frequency axis by not transmitting a PRS.

The basic pattern of FIG. 11 may be repeated based on a two-subframe unit, and a basic pattern based on a subframe unit may also be configurable.

A PRS may be transmitted by distinguishing BSs based on the method of FIG. 11 and thus, a frequency band that transmits a PRS is different for each subframe. Accordingly, the method FIG. 11 is an advanced structure when compared to the method of FIG. 9. The method of FIG. 9 may transmit a PRS through a total frequency band and thus, a frequency-diversity and a time-diversity may be simultaneously obtained.

In the current LTE system, a PRS with respect to a single subframe and one RB along a frequency axis may be transmitted at regular intervals, such as 160 ms (160 subframes), 320 ms (320 subframes), 640 ms (640 subframes), or 1280 ms (1280 subframes), with a predetermined offset with respect to a time axis, through use of consecutive subframes, such as 1 subframe, 2 subframes, 4 subframes, or 6 subframes. In terms of the above standard, the transmission subframes for all types of PRSs may be covered by repeating the two-subframe based muting pattern described in the foregoing with reference to FIG. 8 or FIG. 9.

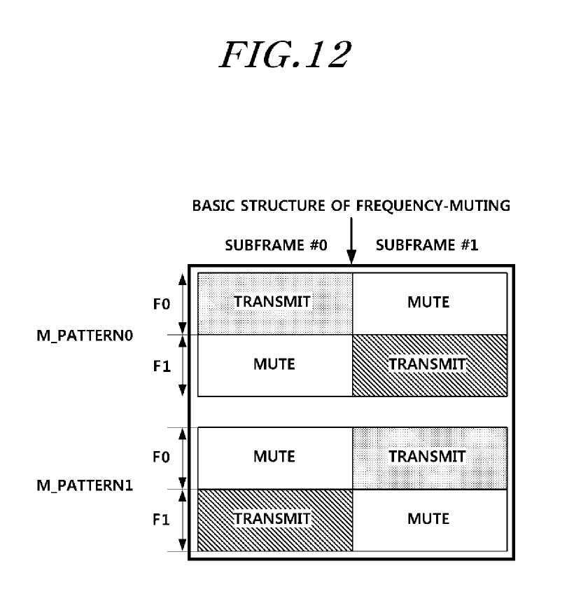

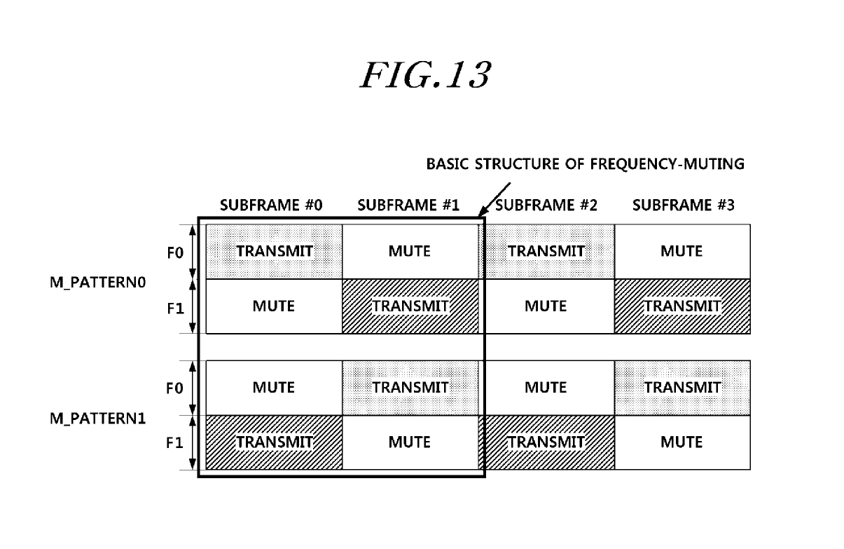

FIG. 12, FIG. 13, FIG. 14 illustrate a hybrid-type based muting method of FIG. 11 when a number of consecutive PRS subframes allocated for transmitting a PRS is 2, 4, or 6.

Referring to FIG. 12, FIG. 13, and FIG. 14, a total frequency band allocated to a wireless communication system along a frequency axis with respect to N consecutive subframes that are allocated for transmitting a PRS at regular intervals may be divided into two frequency bands.

The wireless communication system may group BSs into three BS groups, that is, cell groups 1 through 3. Based on a two-subframe unit, the cell group 1 (M_pattern=0) may transmit a PRS in an odd subframe of an odd frequency band (F0) and in an even subframe of an even frequency band (F1) from among the N consecutive subframes, and may mute remaining subframes by not transmitting a PRS.

Conversely, based on a two-subframe unit, the cell group 2 (M_pattern=1) may transmit a PRS in an even subframe of the odd frequency band (F0) and in an odd subframe of the even frequency band (F1) from among the N consecutive subframes, and may mute remaining subframes by not transmitting a PRS.

The cell group 3 (none of muting) may transmit a PRS to the total frequency band allocated to the wireless communication system along the frequency axis with respect to the N consecutive subframes, or may mute the total frequency band by not transmitting a PRS.

As described in the foregoing with reference to FIG. 12, FIG. 13, and FIG. 14, the wireless communication system divides the allocated total frequency band into two frequency bands and repeat a frequency muting pattern based on a two-subframe unit and thus, may use the same frequency muting pattern irrespective of a number of consecutive subframes (M).

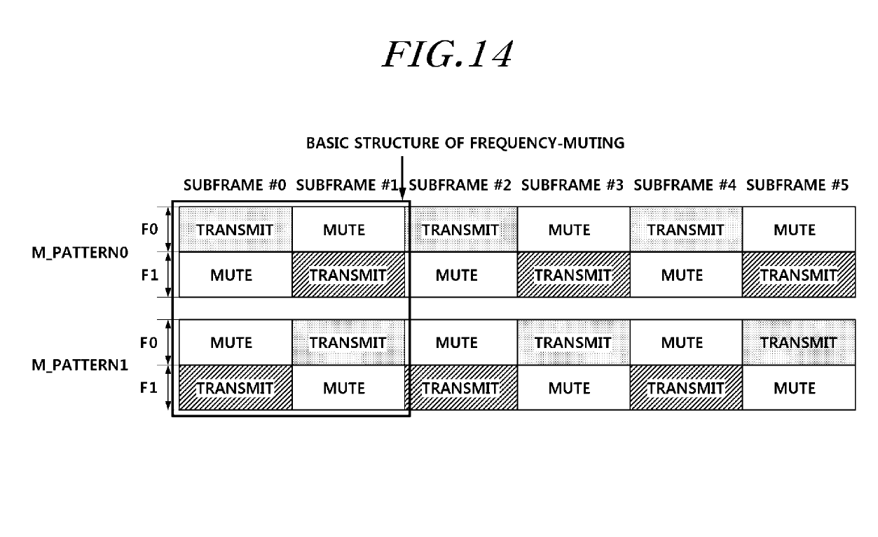

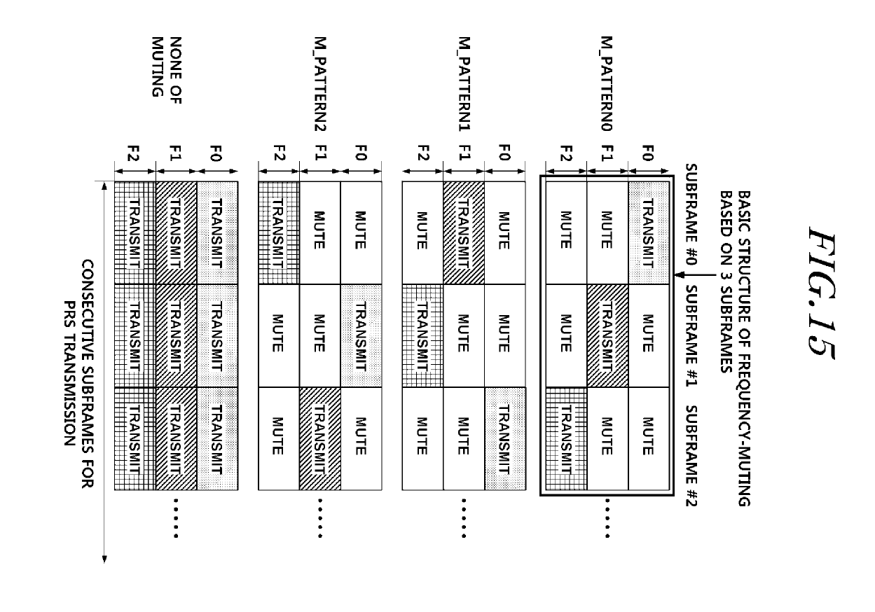

FIG. 15 illustrates a frequency muting method that transmits a PRS based on a frequency band-based muting pattern when L corresponding to a number of divided frequency bands is 3.

Referring to FIG. 15, a total frequency band allocated to a wireless communication system along a frequency axis with respect to N consecutive subframes that are allocated for transmitting a PRS at regular intervals may be divided into three frequency bands.

The wireless communication system may group BSs into four BSs, that is, cell groups 1 through 4. Based on a three-subframe unit, the cell group 1 (M_pattern=0) may transmit a PRS in a first subframe (subframe #0) of a first frequency band (F0) from among the N consecutive subframes, and may mute second and third subframes (subframes #1 and #2) by not transmitting a PRS or transmitting a PRS with zero (0) power. Also, the cell group 1 may transmit a PRS in a second subframe (subframe #1) of a second frequency band (F1), and may mute first and third subframes (subframes #0 and #2) by not transmitting a PRS or transmitting a PRS with zero (0) power. Also, the cell group 1 may transmit a PRS in a third subframe (subframe #2) of a third frequency band (F2), and may mute first and second subframes (subframes #0 and #1) by not transmitting a PRS or transmitting a PRS with zero (0) power.

Based on a three-subframe unit, the cell group 2 (M_pattern=1) may transmit a PRS in the third subframe (subframe #2) of the first frequency band (F0), the first subframe (subframe #0) of the second frequency band (F1), and the second subframe (subframe #1) of the third frequency band (F2), and may mute remaining subframes by not transmitting a PRS or transmitting a PRS with zero (0) power.

Based on a three-subframe unit, the cell group 3 (M_pattern=4) may transmit a PRS in the second subframe (subframe #1) of the first frequency band (F0), the third subframe (subframe #2) of the second frequency band (f1), and the first subframe (subframe #0) of the third frequency band (F2), and may mute remaining subframes by not transmitting a PRS or transmitting a PRS with zero (0) power.

The cell group 4 (none of muting) may transmit a PRS to the total frequency band allocated to the wireless communication system along the frequency axis with respect to the N consecutive subframes, that is, the odd frequency band (F0) and the even frequency band (F0). In this example, the cell group 4 may mute the total frequency band allocated to the wireless communication system along the frequency axis by not transmitting a PRS.

The transmission subframes for a PRS when a number of consecutive PRS subframes N is 3 or 6 may be covered by repeating the three-subframe based muting pattern as described with reference to FIG. 15.

A downdrift in inter-cell interference of a muting pattern may vary based on a multi-cell arrangement. Hereinafter, a method of allocating a muting pattern to a single cell-site including a plurality of cells in a wireless communication environment will be described.

Examples of PRS transmission or muting that is patterned based on a frequency and a time in a form of a grid have been provided in the foregoing with reference to FIG. 5, FIG. 6, FIG. 7, FIG. 8, FIG. 9, FIG. 10, FIG. 11, FIG. 12, FIG. 13, FIG. 14, and FIG. 15. In particular, a time domain having a transmission period of a PRS as an axis and a frequency domain having an available total frequency as an axis may be divided. A pattern (muting pattern) associated with a domain that performs muting from among the divided domains may be shared between a BS and a UE, and the BS may transmit a PRS based on the muting pattern. BSs in neighbor cells may transmit a PRS based on another muting pattern that performs muting in domains that are partially or completely different from the domain indicated by the muting pattern. Accordingly, the UE may receive a PRS from one or a few BSs in a frequency-time domain muted based on a muting pattern and thus, interference may be reduced.

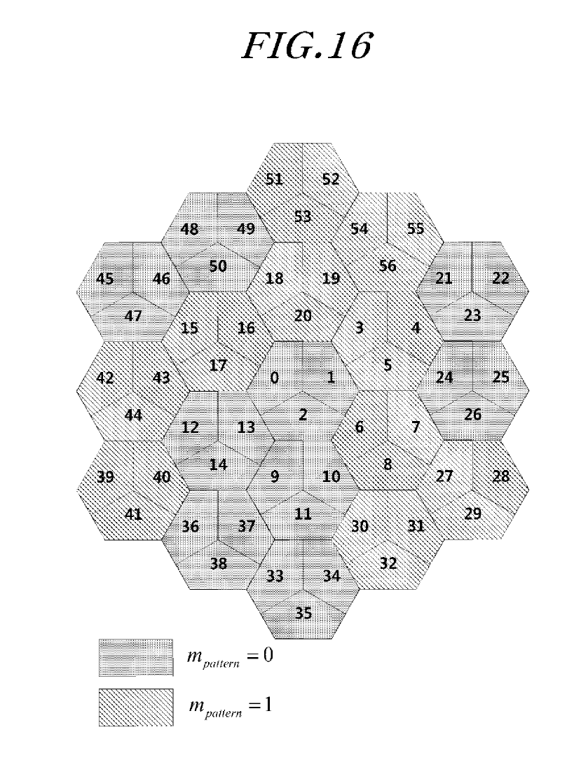

FIG. 16 illustrates a method of transmitting a PRS by arranging a BS or a cell according to the same muting pattern based on a single cell-site unit including a plurality of cells according to another exemplary embodiment of the present invention.

The cell-site may be defined based on a plurality of cells or a plurality of sectors. In a wireless communication environment configured by assuming a general 3-sector antenna, three cells or sectors may configure a single cell-site. For examples, three cells or sectors, such as cell 0 through cell 2, cell 3 through cell 5, and the like, may configure a single cell-site.

In the wireless communication environment, BSs (cells) may be arranged according to the same muting pattern based on a single cell-site unit including the three cells, or cells may be designed to have the same muting pattern in the same cell-site, through use of Equation 6.

v_{shift}=N_{cell}^{ID} mod 6

mₚₐₜₜₑᵣₙ=(└N_{cell}^{ID}/3┘+└N_{cell}^{ID}/6┘)mod 2 [Equation 6]

Here, v_{shift} denotes a parameter to generate different PRS patterns as described in FIG. 2 and FIG. 3. Generated frequency muting patterns may be M_pattern 0 (mₚₐₜₜₑᵣₙ=0) and M_pattern 1 (mₚₐₜₜₑᵣₙ=1). In this example, the multi-cell arrangement may be represented as shown in FIG. 14.

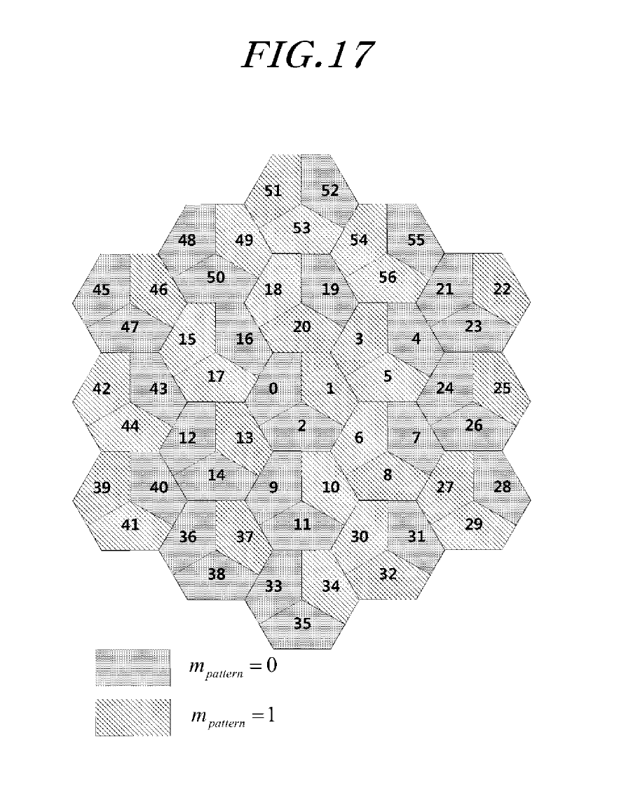

FIG. 17 illustrates a method of transmitting a PRS by arranging, based on a corresponding muting pattern, a BS or a cell in each sector or each cell of a single cell-site including a plurality of cells according to another exemplary embodiment of the present invention.

In the wireless communication environment as shown in FIG. 16, a few cells in a single cell-site including three cells may be designed to have the same muting pattern or to have different muting patterns from each other, through use of Equation 7.

v_{shift}=N_{cell}^{ID} mod 6

mₚₐₜₜₑᵣₙ=(N_{cell}^{ID}+└N_{cell}^{ID}/6┘)mod 2 [Equation 7]

Here, v_{shift} denotes a parameter to generate different PRS patterns as illustrated in FIG. 2 and FIG. 3. Two frequency muting patterns may be provided in total and generated frequency muting patterns may be M_pattern 0 (mₚₐₜₜₑᵣₙ=0) and M_pattern 1 (mₚₐₜₜₑᵣₙ=1). In this example, a multi-cell arrangement may be represented as shown in FIG. 15.

Referring to FIG. 17, a few cells may have the same muting patterns, or may have the different muting patterns from each other in the single cell-site.

In this example, in each BS 20, a bandwidth associated with a frequency axis for a PRS, a period of a subframe used for transmission of a PRS and an offset associated with a time axis, and a number of consecutive subframes used for transmission of a PRS may be controlled by a higher layer, and the information may be transmitted to each UE 10 through a higher layer, for example, an RRC.

In this example, a number of cell groups (M), a number of cells per group or a length of consecutive PRS subframes that perform transmission as opposed to performing muting from among the allocated N consecutive subframes (k), and a number of frequency bands obtained by dividing the total frequency band allocated to the wireless communication system along a frequency axis (L) may be optimally selected by a BS 20 or core network.

The frequency band-based muting method for PRS transmission according to the exemplary embodiment may configure different muting patterns for PRSs by simply dividing a frequency band, and may reduce a number of cells using the same resource in a frequency and thus, inter-cell interference may be efficiently reduced.

The frequency band-based muting method for PRS transmission according to the exemplary embodiment may be readily applied irrespective of a number of subframes that transmit consecutive PRSs during a predetermined period and thus, transmission of additional information may not be required in a network or sufficient information may be transferred through use of at most 1 bit of additional information per cell. That is, additional secondary data of a higher layer, such as L2, L3, and the like, may not be required or an OTDOA-based positioning method may be efficiently managed through use of at most 1 bit.

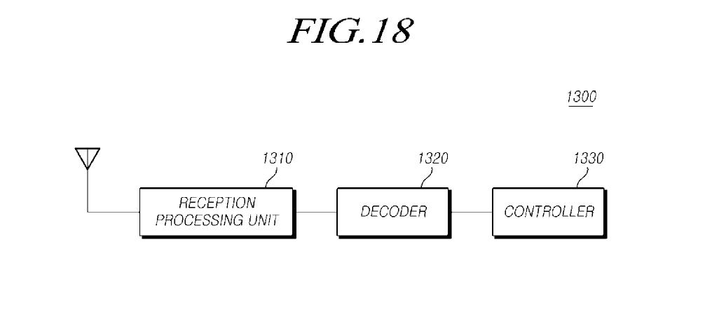

FIG. 18 illustrates a UE according to another exemplary embodiment of the present invention.

Referring to FIG. 18, a receiving apparatus 1300 of the UE 10 may include a reception processing unit 1310, a decoder 1320, and a controller 1330.

The reception processing unit 1310 may receive, from at least three different BSs 20, PRSs of which PRS patterns and muting patterns are different from each other.

The decoder 1320 may recognize a muting pattern of each cell and may decode a PRS based on a general positioning scheme. The decoder 1320 may decode the received PRSs of which PRS patterns and muting patterns are different from each other, the PRS being received by the reception processing unit 1310 from the at least three different BSs 20.

The controller 1330 may estimate a distance from each BS 20 based on relative arrival times of the PRSs that are received from the at least three different BSs 20 and are decoded by the decoder 1320, according to the OTDOA method, and may estimate its location based on a triangulation method.

Hereinafter, the operations of the receiving apparatus 1300 of the UE 10 for positioning will be described.

A signal received through each antenna port may be converted into a complex time domain signal by the reception processing unit 1310. Also, the reception processing unit 1310 may extract PRSs allocated to predetermined resource elements, from the received signal based on a PRS pattern and a muting pattern. The decoder 1312 may decode the extracted PRSs. The controller 1014 may measure a distance from a BS 20 based on a relative arrival time from the BS 20, through use of information associated with the decoded PRSs. In this example, the controller 1014 may calculate a distance from the BS 20 based on the relative arrival time from the BS 20, or the controller 1014 may transmit the relative arrival time to the BS 20 so that the BS 20 may calculate the distance. In this example, distances from the at least three BSs 20 may be measured and thus, the location of the UE 10 may be calculated.

The receiving apparatus 1300 may correspond to the wireless communication system or the transmitting apparatus 400 described with reference to FIG. 4 and thus, may receive a signal transmitted from the transmitting apparatus 400. Accordingly, the receiving apparatus 1300 may be configured of elements for reversely performing a signal processing of the transmitting apparatus 400. Therefore, elements of the receiving apparatus 1300 that are not described in detail may be understood to be replaced with elements for reversely performing a signal processing of the transmitting apparatus 400.

That is, operations of a UE may include receiving a first PRS transmitted based on a first muting pattern that does not transmit a PRS in a first frequency-time domain defined by a first frequency domain and a first time domain, receiving a second PRS transmitted based on a second muting pattern that does not transmit a PRS in a second frequency-time domain, different from the first frequency-time domain, decoding the first PRS and the second PRS, and performing positioning based on arrival times of the decoded first PRS and second PRS. Also, the UE may further receive a PRS for positioning.

First muting pattern information associated with the first muting pattern and second muting pattern information associated with the second muting pattern may be received from a BS through use of a higher layer, to receive/decode each PRS and to determine an arrival time.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of transmitting a signal in a wireless communication system, the method comprising the steps of:
dividing, into L frequency bands, a total frequency band allocated to a frequency axis with respect to N consecutive subframes that are allocated for transmitting a positioning reference signal (PRS) at regular intervals; and
performing muting by not transmitting a PRS to at least one frequency band with respect to at least one of the N subframes, and transmitting a PRS to remaining frequency bands.

2. The method as claimed in claim 1, wherein, when L is 2, the method comprises the steps of:
dividing the total frequency band allocated to the N subframes into two frequency bands; and
repeatedly performing a frequency muting pattern based on a two-subframe unit,
wherein the frequency muting pattern comprises:
performing muting by not transmitting a PRS to at least one frequency band, and
transmitting a PRS to a remaining frequency band.

3. The method as claimed in claim 2, wherein:
one of the two frequency bands transmits a PRS with respect to the N consecutive subframes allocated for transmitting a PRS at regular intervals; and
the other frequency band performs muting by not transmitting a PRS with respect to the N consecutive subframes allocated for transmitting a PRS at regular intervals.

4. The method as claimed in claim 2, wherein:
one of the two frequency bands transmits a PRS to one subframe in the two-subframe unit, and performs muting by not transmitting a PRS to the other subframe;
the other frequency band transmits a PRS to the other subframe, and performs muting by not transmitting a PRS to the one subframe; and
the frequency muting pattern is repeatedly performed with respect to N consecutive subframes allocated for transmitting a PRS at regular intervals.

5. The method as claimed in claim 1, wherein, when L is 3, the method comprises the steps of:
dividing the total frequency band allocated to the N subframes into three frequency bands; and
transmitting a PRS or performing muting by not transmitting a PRS, and repeatedly performing a frequency muting pattern based on a three-subframe unit.

6. The method as claimed in claim 5, wherein, from among three frequency bands obtained by dividing the total frequency band allocated for the N consecutive subframes:
one frequency band transmits, based on a three-subframe unit, a PRS at a first subframe of a first frequency band (F0) from among the N consecutive subframes, and performs muting by not transmitting a PRS at a second subframe and a third subframe;
another frequency band transmits a PRS at the second subframe, and performs muting by not transmitting a PRS at the third subframe and the first subframe; and
the other frequency band transmits a PRS at the third subframe, and performs muting by not transmitting the PRS at the first subframe and the second subframe.

7. The method as claimed in claim 1, wherein the N subframes are allocated for transmitting a PRS at regular intervals, N is one of 2, 4, and 6, and the regular intervals is one of 160 ms, 320 ms, 640 ms, and 1280 ms.

8. The method as claimed in claim 1, wherein a pattern of a PRS of a subframe forms, based on a predetermined sequence, a basic PRS pattern in ½ of a resource block including two slots forming a single subframe and six OFDM subcarriers, forms a primary basic PRS pattern in a location of a subcarrier on a frequency domain corresponding to an i^{th} value of the sequence with respect to each i^{th} symbol from the last, here a length of the predetermined sequence being N, and 1≦i≦N in the two slots, and punctures, from the primary basic PRS pattern, a PRS pattern formed in a location corresponding to a control region, a symbol axis where a CRS exists, and an reference element (RE) where a PSS, a SSS and a BCH exist.

9. A transmitting apparatus, comprising:
a scrambler to scramble bits input in a form of code words after channel coding in a downlink;
a modulation mapper to modulate the bits scrambled by the scrambler into a complex modulation symbol;
a layer mapper to map a complex modulation symbol to one or more transmission layers;
a pre-coder to perform pre-coding of a complex modulation symbol in each transmission channel of an antenna port;
a resource element mapper to map a complex modulation symbol associated with each antenna port to a corresponding resource element; and
a positioning reference signal (PRS) resource allocator to divide, into L frequency bands, a total frequency band allocated to a frequency axis with respect to N consecutive subframes allocated for transmitting a PRS at regular intervals, and to perform mapping on a resource element so as to perform muting by not transmitting a PRS to at least one frequency band with respect to at least one of the N subframes, and transmitting a PRS to remaining frequency bands.

10. A receiving apparatus, comprising:
a reception processing unit to extract, from a signal received through each antenna port, positioning reference signals (PRSs) allocated to predetermined resource elements, through use of a PRS pattern and a muting pattern;
a decoder to decode the extracted PRSs; and
a controller to perform controlling so as to calculate a distance from a cell based on a relative arrival time of the signal from the cell through use of the decoded PRSs or to transmit the relative arrival time.

11. A method of transmitting a reference signal, the method comprising the steps of:
selecting a first muting pattern that does not transmit a positioning reference signal (PRS) in a first frequency-time domain that is defined by a first frequency domain of a total frequency band available to a first base station (BS) and a first time domain of a transmission period of a PRS;
transmitting information associated with the selected first muting pattern to a user equipment (UE); and
generating a PRS based on the first muting pattern and transmitting the generated PRS.

12. The method as claimed in claim 11, wherein:
the first frequency domain is one or more frequency bands from among frequency bands obtained by dividing the total frequency band into L frequency bands; and
the first time domain is one or more subframes from among N consecutive subframes forming the transmission period.

13. The method as claimed in claim 11, wherein the step of transmitting the information associated with the selected first muting pattern is performed through use of a higher layer than a layer used for transmitting the generated PRS.

14. The method as claimed in claim 11, wherein the step of generating and transmitting the PRS further comprises the steps of:
determining a pattern that transmits a PRS in a second frequency-time domain as opposed to the first frequency-time domain; and
generating a sequence for a PRS based on the pattern.

15. The method as claimed in claim 11, wherein the first frequency domain is one of domains obtained by logically dividing the total frequency domain, and the first frequency domain is physically dispersed into a frequency axis.

16. The method as claimed in claim 11, wherein the total frequency domain is divided into L frequency domains and the transmission period is divided into K periods so that a total frequency-time domain is distinguished by L×K frequency-time domains, and the first frequency-time domain includes one or more frequency-time domains from among the L×K frequency-time domains.

17. The method as claimed in claim 16, wherein:
the first BS transmits a PRS based on the first muting pattern that indicates the first frequency-time domain among the L×K frequency-time domain; and
a second BS in a neighbor cell of the first BS transmits a PRS based on a second muting pattern that indicates a second frequency-time domain including one or more frequency-time domains, different from the first frequency-time domain, from among the L×K frequency-time domains.

18. A method of receiving a reference signal, the method comprising the steps of:
receiving a first positioning reference signal (PRS) based on a first muting pattern that does not transmit a PRS in a first frequency-time domain defined by a first frequency domain and a first time domain;
receiving a second PRS based on a second muting pattern that does not transmit a PRS in a second frequency-time domain that is different from the first frequency-time domain;
decoding the first PRS and the second PRS; and
performing positioning based on arrival times of the decoded first PRS and the decoded second PRS.

19. The method as claimed in claim 18, wherein:
the first frequency domain is one or more frequency bands obtained by dividing a total frequency band into L frequency bands; and
the first time domain is one or more subframes from among N consecutive subframes forming a transmission period of a PRS.

20. The method as claimed in claim 18, further comprising the step of:
receiving first pattern information associated with the first muting pattern and second muting pattern information associated with the second muting pattern.

21. The method as claimed in claim 18, wherein the first frequency domain is one of domains obtained by logically dividing a total frequency domain, and the first frequency domain is physically dispersed into a frequency axis.

22. The method as claimed in claim 18, wherein:
a total frequency domain is divided into L frequency domains and the transmission period is divided into K periods so that a total frequency-time domain is distinguished by L×K frequency-time domains;
the first frequency-time domain includes one or more frequency-time domains from among the L×K frequency-time domains; and
the second frequency-time domain includes one or more frequency-time domains, different from the first frequency-time domain, from among the L×K frequency-time domains.

23. An apparatus to transmit a reference signal, the apparatus comprising:
a sequence generator to generate a sequence for a positioning reference signal (PRS);
a resource allocator to allocate a PRS to a resource element based on a first muting pattern that does not transmit a PRS in a first frequency-time domain that is defined by a first frequency domain of an available total frequency band and a first time domain of a transmission period of a PRS; and
a transmitting unit to transmit an allocated resource through use of a physical channel.

24. The apparatus as claimed in claim 23, wherein:
the first frequency domain is one or more frequency bands from among frequency bands obtained by dividing the total frequency band into L frequency bands; and
the first time domain is one or more subframes from among N consecutive subframes forming the transmission period.

25. The apparatus as claimed in claim 24, further comprising:
a Radio Resource Controller (RRC) controller to generate higher layer information so as to transmit first muting pattern information to a user equipment (UE).

26. The apparatus as claimed in claim 24, wherein the sequence allocator determines a pattern that transmits a PRS in a second frequency-time domain as opposed to the first frequency-time domain, and generates a sequence for the PRS based on the pattern.

27. The apparatus as claimed in claim 24, wherein the first frequency domain is one of domains obtained by logically dividing the total frequency domain, and the first frequency domain is physically dispersed into a frequency axis.

28. The apparatus as claimed in claim 24, wherein the total frequency domain is divided into L frequency domains and the transmission period is divided into K periods so that a total frequency-time domain is distinguished by L×K frequency-time domains, and the first frequency-time domain includes one or more frequency-time domains from among the L×K frequency-time domains.

29. The apparatus as claimed in claim 28, wherein:
the transmitting unit transmits a PRS based on the first muting pattern that indicates the first frequency-time domain from among the L×K frequency-time domains; and
a base station in a neighbor cell transmits a PRS based on a second muting pattern that indicates a second frequency-time domain including one or more frequency-time domains, different from the first frequency-time domain, from among the L×K frequency-time domain.

30. An apparatus to receive a reference signal, the apparatus comprising:
a receiving unit to receive a first positioning reference signal (PRS) transmitted based on a first muting pattern that does not transmit a PRS in a first frequency-time domain defined by a first frequency domain and a first time domain, and to receive a second PRS transmitted based on a second muting pattern that does not transmit a PRS in a second frequency-time domain, different from the first frequency-time domain;
a decoder to decode the first PRS and the second PRS; and
a controller to perform positioning based on arrival times of the decoded first PRS and the decoded second PRS.

31. The apparatus as claimed in claim 30, wherein:
the first frequency domain is one or more frequency bands from among frequency bands obtained by dividing a total frequency band into L frequency bands; and
the first time domain is one or more subframes from among N consecutive subframes forming a transmission period of a PRS.

32. The apparatus as claimed in claim 30, further comprising:
a Radio Resource Controller (RRC) controller to receive first muting pattern information associated with the first muting pattern and second muting pattern information associated with the second muting pattern, through use of a higher layer.

33. The apparatus as claimed in claim 30, wherein the first frequency domain is one of frequency domains obtained by logically dividing a total frequency domain, and the first frequency domain is physically dispersed into a frequency axis.

34. The apparatus as claimed in claim 30, wherein:
a total frequency domain is divided into L frequency domains and the transmission period is divided into K periods so that the total frequency-time domain is distinguished by L×K frequency-time domains;
the first frequency-time domain includes one or more frequency-time domains from among the L×K frequency-time domains; and
the second frequency-time domain includes one or more frequency-time domains, different from the first frequency-time domain, from among the L×K frequency-time domains.
